(19) United States
(12) Patent Application Publication
(10) Pub. No.: US 2026/0067714 A1
(43) Pub. Date: Mar. 5, 2026

(54) CUSTOMER EXPERIENCE FIRST MODEL

(71) Applicant: T-MOBILE INNOVATIONS LLC, Overland Park, KS (US)

(72) Inventors: Ramesh Venkata JOSYULA, Redmond, WA (US); Kiranpal Singh CHAGGAR, Bellevue, WA (US); Amembal Vikram PAI, Bothell, WA (US); Satish Subramanya PACHALLA, Sammamish, WA (US); Baquer Ali CHABUK SAVAR, Auburn, WA (US)

(21) Appl. No.: 18/818,188

(22) Filed: Aug. 28, 2024

(51) Int. Cl. H04W 24/02; G06N 5/022; H04L 41/5009

(52) U.S. Cl. CPC H04W 24/02; G06N 5/022; H04L 41/5009

(57) ABSTRACT

Anomalies are detected corresponding to user equipment (UE) performance degradation. A neural network is trained using historical network key performance indicators (KPIs), customer retention metrics, and network KPIs. As a result, the trained neural network is configured to output a plurality of customer impact zones, including a threshold for each of the plurality of customer impact zones. The trained neural network may further identify an anomaly that has caused the UE's performance degradation to exceed a threshold and identify an actionable field task that may be implemented by a field team and that may lower the UE's performance degradation below a threshold.

### TECHNICAL FIELD

This technology relates to detecting changes in the measured perspective of a customer in a telecommunications network in order to provide enhanced customer service.

### SUMMARY

At a high level, aspects described herein relate to machine learning for determining the measured perspective of an individual customer using a network, such as a telecommunications network. In particular, the measured perspective of a customer, or the relative change in a customer's experience, can be determined using multiple machine learning models. In a specific example, a neural network is trained to output the measured perspective of a customer. This can be done by training the neural network, using a machine learning model, on certain key performance indicators (KPIs) related to the frequency, intensity, relativity, sensitivity and time (FIRST) of adverse customer experiences so that the trained neural network outputs the measured perspective of a customer.

Measuring the perspective of a customer includes determining, using the trained neural network, impact zones specific to the customer. The neural network is trained on historical data related to network KPIs, customer satisfaction, and customer retention. The neural network is further trained on the customer's historical KPI data, and the customer's current KPI data. The trained neural network may then output one or more anomalies that indicate the performance degradation for the customer has exceeded a threshold. The neural network may further output an actionable field task addressing the one or more anomalies, which when implemented, will lower the exceeded threshold

This summary is intended to introduce a selection of concepts in a simplified form that are further described below in the detailed description section of this disclosure. This summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the following or learned by practice of the technology.

### BRIEF DESCRIPTION OF THE DRAWINGS

The present technology is described in detail below with reference to the attached drawing figures, wherein:

FIG. 1 is an example operating environment in which a customer experience FIRST system may be employed in accordance with an embodiment described herein;

FIG. 2 depicts a customer anomaly detection system, in accordance with an embodiment described herein;

FIG. 3 is a flowchart of a method for detecting network anomalies corresponding to UE performance degradation, in accordance with an embodiment described herein;

FIG. 4 is a flowchart of another method for detecting network anomalies corresponding to UE performance degradation, in accordance with an embodiment described herein; and

FIG. 5 is an example computing device suitable for implementing the described technology, in accordance with an embodiment described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s)) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” and “radio access network (RAN) node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, reducing subscriber churn rate is a principle objective for a telecommunications network operator. The churn rate refers to the percentage of service subscribers who chose to discontinue their network subscription. Churn rate is used to gauge customer retention, but also to understand customer satisfaction and identify areas for improvement. A network operator may seek to reduce churn rate by enhancing customer service, improving network quality, and offering competitive pricing.

Conventionally, systems and methods capable of addressing customer churn rate are based on aggregated data points that represent the average or typical experience of customers across the network. Network performance metrics or key performance indicators (KPIs) including data on bandwidth, latency, jitter, packet loss, and overall network stability as well as customer satisfaction metrics like complaint rates and service quality ratings are evaluated by examining the average experience for a number of customers. These averages aid in identifying general trends, making strategic decisions, and measuring the effectiveness of broader network improvements. However, these data points fail to illustrate an individual customer's experience relative to the customer's usual or baseline experience.

Unlike conventional systems and methods, the methods, systems and operations disclosed herein provide a controlled way of reducing customer churn by detecting and addressing anomalies which exceed a threshold specific to an individual customer. The present disclosure describes using machine learning to determine the relative change in an individual customer's experience. A neural network is trained, using a machine learning model, on a number of network KPIs related to performance of the network, as well as customer satisfaction metrics, and customer retention metrics. Historical KPI data associated with an individual customer is then input into the trained neural network, which generates various impact zones for the individual customer based on the customer's historical KPI data. Current KPI data associated with the individual customer is then input into the machine learning model, which outputs a relative change in the individual customer's experience. The machine learning model further generates output comprising one or more anomalies that indicate the individual's performance degradation has exceeded a threshold as well as an actionable field task to lower the individual's performance degradation.

As will be described, methods of machine learning can be employed to identify anomalies. In particular, methods of using multiple trained machine learning models can be used to better identify threshold changes to an individual customer's relative experience as compared to conventional methods.

Accordingly, a first aspect of the present disclosure provides a computerized method for detecting network anomalies corresponding to user equipment (UE) performance degradation, the method performed by one or more processors. The method inputting into a machine learning model a plurality of key performance indicators (KPIs) that are used to measure performance trends of a plurality of UEs. The method further comprises accessing historical data associated with the plurality of KPIs for the plurality of UEs. The method further comprises training the machine learning model on the historical data as applied to the KPIs to receive output by the machine learning model, the output comprising one or more anomalies that indicate that the UE performance degradation has exceeded a threshold.

A second aspect of the present disclosure provides one or more computer storage media storing computer-readable instructions that when executed by a processor, cause the processor to perform a method for detecting network anomalies corresponding to user equipment (UE) performance degradation. The method comprises inputting into a machine learning model a plurality of key performance indicators (KPIs) that are used to measure performance trends of a plurality of UEs. The method further comprises accessing historical data associated with the plurality of KPIs for the plurality of UEs. The method further comprises training the machine learning model on the historical data as applied to the KPIs. The method further comprises generating, by the machine learning model, output comprising one or more anomalies that indicate that the UE performance degradation has exceeded a threshold.

A third aspect of the present disclosure provides a system for detecting network anomalies corresponding to user equipment (UE) performance degradation. The system comprises at least one processor. The system further comprises one or more computer storage media having computer-usable instructions embodied thereon that when executed by the at least one processor, cause the at least one processor to determine a plurality of impact zones for a UE using a trained impact zone model, the impact zone model having been trained on a series of historical data associated with performance trend outputs of a trained neural network configured to generate performance trends in response to historical data associated with a plurality of key performance indicators (KPIs). The processors are further caused to determine an impact zone threshold for the UE using the trained neural network, wherein the impact zone threshold is determined by the trained neural network in response to receiving historical data associated with a plurality of UEs. The processors are further caused to determine current performance trends for the UE using the trained neural network, wherein the current performance trends are determined by the trained neural network in response to receiving current KPIs for a UE. The processors are further caused to identify current performance trends which exceed the impact zone threshold.

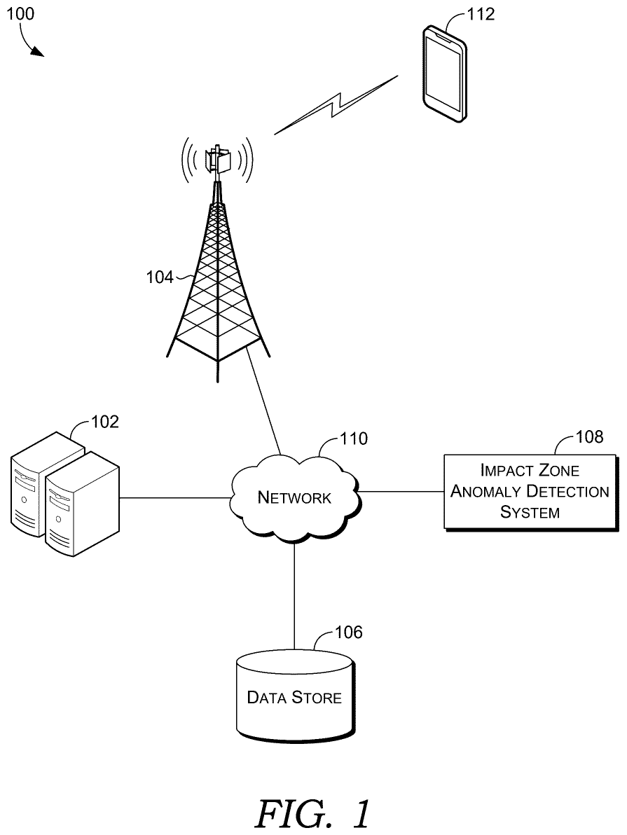

With reference now to FIG. 1, FIG. 1 illustrates example operating environment 100 in which aspects of the technology can be employed. Operating environment 100 comprises server(s) 102, cell site 104 of a wireless communications network, data store 106, and an impact zone anomaly detection system 108, for detecting network anomalies corresponding to user equipment (UE) performance degradation, which are each communicating via network 110. FIG. 1 also illustrates mobile device 112 in wireless communication with cell site 104 within the wireless communications network.

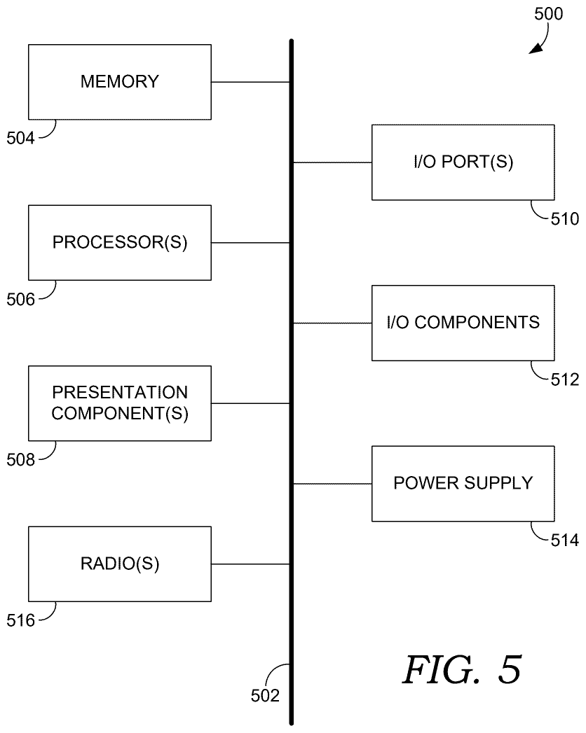

Server 102 represents one more servers configured in any arrangement. Server 102 generally employs aspects of network anomaly detection engine 108, which generally identifies network anomalies corresponding to user equipment (UE) performance degradation. Server 102 may be any computing device. One example computing device suitable for use as server 102 is computing device 500 of FIG. 5.

By way of background, a traditional wireless communication network employs one or more wireless access points to provide wireless access to mobile stations, in order that they may access a telecommunication network. For example, in a wireless telecommunication network, a plurality of access points, each providing service for a particular geographic area, are used to transmit and receive wireless signals to or from one or more devices, such as mobile devices. For the purposes of this specification, an access point may be considered to be one or more otherwise discrete components comprising an antenna, a radio, or a controller, and may be alternatively referred to as a “node,” in that it is a bridge between the wired telecommunication network and the wirelessly connected devices.

As used herein, the term “access point” can also be synonymous with the terms “node” or “base station,” or another like term. The terms “user device,” “user equipment,” “UE,” “mobile device,” “mobile handset,” and “mobile transmitting element” all describe a mobile station and may be used interchangeably in this description. A “mobile device” or other like term, as used herein, is a device that has the capability of using a wireless communications network. A mobile device may take on a variety of forms, such as a personal computer (PC), a laptop computer, a tablet, a mobile phone, a personal digital assistant (PDA), a server, or any other device that is capable of communicating with other devices using a wireless communications network. Additionally, embodiments of the present technology may be used with different technologies or standards, including, but not limited to, CDMA 1XA, GPRS, EvDO, TDMA, GSM, WiMax technology, LTE, or LTE Advanced, 5G, 6G, among other technologies and standards.

Cell site 104 is configured to wirelessly communicate between the one or more mobile devices, such as mobile device 112, and within the wireless communications network. As used herein, the term “cell site” is used generally to refer to one or more cellular base stations, nodes, RRU control components, and the like (configured to provide a wireless interface between a wired network and a wirelessly connected user device), which are geographically concentrated at a particular site so as not to obscure the focus of the present invention. Though illustrated as a macro site, the cell site 202 may be a macro cell, small cell, femto cell, pico cell, or any other suitably sized cell, as desired by a network carrier for communicating within a particular geographic area. In aspects, the cell site 202 may comprise one or more nodes (e.g., NodeB, eNodeB, ng-eNodeB, gNodeB, en-gNodeB, and the like) that are configured to communicate with user devices in one or more discrete geographic areas using one or more antennas of an antenna array.

Datastore 106 generally stores information, including data, computer instructions (e.g., software program instructions, routines, or services), or models used in embodiments of the described technologies. Although depicted as a single database component, datastore 106 may be embodied as one or more data stores or may be in the cloud. In an aspect, datastore 106 stores computer instructions that can be executed by server 102 to perform aspects of impact zone anomaly detection system 108.

Network 110 may include one or more networks (e.g., public network or virtual private network “VPN”) as shown with network 110. Network 110 may include, without limitation, one or more local area networks (LANs), wide area networks (WANs), or any other communication network or method.

Having identified various components of operating environment 100, it is again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of the previously listed components. Other arrangements and elements (e.g., machines, interfaces, functions, orders, and groupings of functions, etc.) can be used in addition to or instead of those shown, and some elements may be omitted altogether.

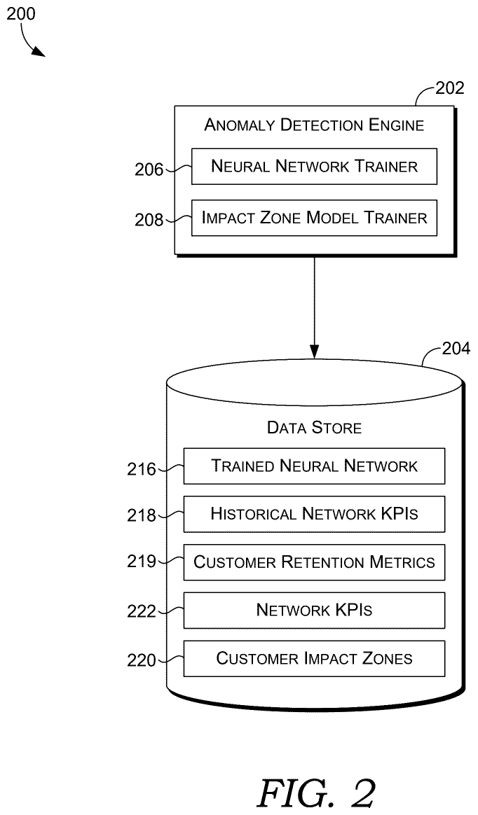

Turning now to FIG. 2, FIG. 2 illustrates an example customer anomaly detection system 200 that is suitable for use as impact zone anomaly detection system 108 illustrated in FIG. 1. In general, the customer network anomaly detection system 200 identifies anomalies in networks which may degrade a customer's relative experience.

As illustrated, customer anomaly detection system 200 comprises anomaly detection engine 202. Anomaly detection engine 202 is one example that can be used to identify anomalies that indicate performance degradation for a customer has exceeded a threshold by measuring the customer's relative experience. The example anomaly detection engine 202 illustrated in FIG. 2 comprises neural network trainer 206 and impact zone model trainer 208.

Many of the elements described in relation to FIG. 2, such as those described in relation to anomaly detection engine 202, are functional entities that may be implemented as discrete or distributed components or in conjunction with other components of FIG. 1, and in any suitable combination and location. Various functions described herein are being performed by one or more entities and may be carried out by hardware, firmware, or software. For instance, various functions may be carried out by a processor executing computer-executable instructions stored in memory. Moreover, the functions described in relation to FIG. 2 may be performed by server 102 at either a front-end, client-side or a back-end, server-side or any combination.

FIG. 2 also illustrates datastore 204. One example suitable for use as datastore 204 is memory 504 of FIG. 5. Data store 204 is one example that may be used as data store 106 of FIG. 1.

As part of detecting network anomalies corresponding to user equipment (UE) performance degradation, anomaly detection engine 202 employs neural network trainer 206. In general, neural network trainer 206 trains a neural network to generate a trained neural network. The trained neural network can be stored in data store 204, such trained neural network 216. The trained neural network 216 may be employed as one of a plurality of machine learning models to identify anomalies in network traffic.

One neural network that can be trained by neural network trainer 206 and that is suitable for use in identifying anomalies in network traffic includes a recurrent neural network (RNN), and other like neural networks. A long short-term memory (LSTM) neural network, or another like model, is on type of RNN that can be used with the present technology. Autoencoders may also be used. One particular example of a neural network trained by network trainer 206 and employed by components of seasonal network anomaly detection engine 202 is an LSTM autoencoder.

Neural network trainer 206 may train a neural network, using historical network KPIs 218, for example, measured from network traffic over a period of time. Historical network KPIs 218 are historical data as applied to the KPIs. The historical network KPIs 218 are used to measure historical performance trends of a plurality of UEs, and may comprise any quantifiable aspect of network KPIs collected from past events or periods of time up to another point in time. Historical network KPIs 218 may relate to the frequency, intensity, relativity, sensitivity, or time of degraded customer experience and can include values such as throughput, bandwidth, number of user devices, and so on. Neural network trainer 206 may employ unsupervised training to train the trained neural network 216 using historical network KPIs 218 measured from network traffic over a period of time. In one method of doing so, the neural network, such as an autoencoder, encodes a time series of KPIs into a lower dimension and then decodes the lower dimensional representation of encoded KPIs. The trained autoencoder can be stored as the trained neural network 216 for use by other components of anomaly detection engine 202.

Neural network trainer 206 may further train a neural network using customer retention metrics 219 measured over a period of time. Customer retention metrics 219 may comprise any quantifiable aspect of customer retention across a network and may indicate a customer's performance degradation is such that the customer is likely to discontinue service or switch providers. This can include values such as churn rate, retention rate, customer satisfaction data, customer survey information, and so on. Neural network trainer 206 can employ unsupervised training to train the trained neural network 216 using customer retention metrics 219 measured over a period of time.

Neural network trainer 206 may further train a neural network using network KPIs 220 measured from network traffic. Network KPIs 220 are used to measure performance trends of a plurality of UEs and may comprise any quantifiable aspect of network KPIs. Network KPIs may relate to the frequency, intensity, relativity, sensitivity, or time of degraded customer experience and can include values such as throughput, bandwidth, number of user devices, and so on. Neural network trainer 206 may employ unsupervised training to train the trained neural network 216 using historical network KPIs 220 measured from network traffic over a period of time.

The time series of historical network KPIs 218, customer retention metrics 219, and network KPIs 220 may comprise any period of time. For example, a period of time may be a one-year period for the time for time series or a three-year period for the time for time series. To keep up with trends in network traffic usage, neural network trainer 206 may be configured to train the trained neural network 216 periodically. One time period for retraining that is sufficient is one week. Thus, in an embodiment, neural network trainer 206 trains a neural network periodically, where the period for training is each week or less. In another embodiment, the training period may be one month or less. Neural network trainer 206 may train the trained neural network 216 on a time series of historical network KPIs 218, customer retention metrics 219, and network KPIs 220, where the time period is one year or less. In another embodiment, the time period is five years or less.

Impact zone model trainer 208 generally trains the trained neural network 216 to output a plurality of customer impact zones, such as customer impact zones 222 in data store 204. In other words, the output of the trained neural network 216 may be a plurality of customer impact zones 222. Customer impact zones 222 may comprise low, medium and high impact zones. Impact zone model trainer 208 may train any type of statistical model or other like model for use by anomaly detection engine 202. For example, the technology can employ statistical models based on Z-Score concept with confidence level based on Q1, Q3, IQR & Median, with the low impact zone having a 90% confidence interval from the baseline median and the high impact zone having a 90%+IQR range from the baseline median.

Impact zone model trainer 208 further trains the trained neural network 216 to output a threshold for each of the plurality of customer impact zones 222, wherein, if exceeded, the customer is likely to experience performance degradation severe enough to discontinue service or switch providers. In other words, the output of the trained neural network 216 may be a threshold for each of the plurality of customer impact zones 222. The threshold may be customer-specific. The threshold may be in the high impact zone of the customer impact zone 220. In another example, the threshold may be in the medium impact zone of the customer impact zone 220. In another example, the threshold may comprise a threshold impact zone. In this example, the threshold may be exceeded when one or more anomalies indicate the UE's performance degradation has exceeded one zone and entered a different zone. For example, if one or more anomalies indicating the UE's performance degradation has moved from the medium zone to the high zone the threshold may be exceeded. In another example, if one or more anomalies indicating the UE's performance degradation has moved from the low zone to the medium zone the threshold may be exceeded The identified threshold is output by the trained neural network 216 and is based at least on historical network KPIs 218, customer retention metrics 219, and network KPIs 220.

To identify anomalies in network traffic that corresponding to user equipment (UE) performance degradation exceeding a threshold, anomaly detection engine 202 employs the trained neural network 216, trained by the neural network trainer 206, using historical network KPIs 218, customer retention metrics 219, and network KPIs 220. The trained neural network 216 may identify one or more anomalies that have caused the UE's performance degradation to exceed a threshold. The trained neural network 216 may further identify an actionable field task that may be implemented by a field team and that may lower the UE's performance degradation below a threshold. Identifying an actionable field task may comprise identifying one or more cells for optimization. Identifying one or more cells for optimization may further comprise prioritizing the one or more cells for optimization.

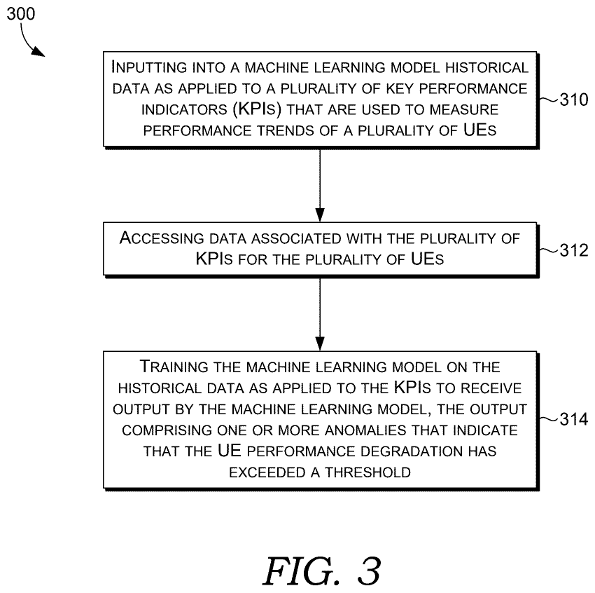

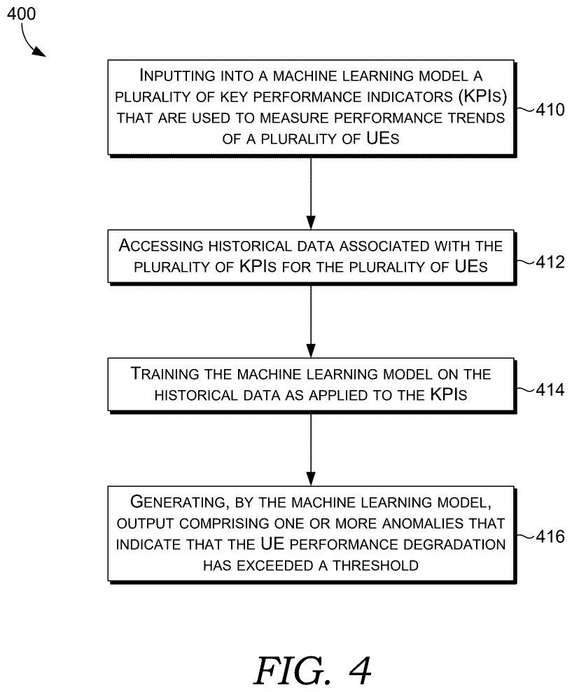

With reference now to FIGS. 3 and 4, flow diagrams are provided that respectively illustrate methods 300 and 400 for detecting network anomalies corresponding to user equipment (UE) performance degradation. Each block of methods 300 and 400 comprises a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. Methods 300 and 400 may be implemented by anomaly detection system 200 of FIG. 2.

FIG. 3 illustrates an example method 300 performed by one or more processors for detecting network anomalies corresponding to UE performance degradation. At block 310, the method comprises inputting into a machine learning model historical data as applied to a plurality of key performance indicators (KPIs) that are used to measure performance trends of a plurality of UEs. The method further comprises, at block 312, accessing data associated with the plurality of KPIs for the plurality of UEs. The method further comprises, at block 314, training the machine learning model on the historical data as applied to the KPIs to receive output by the machine learning model, the output comprising one or more anomalies that indicate that the UE performance degradation has exceeded a threshold.

FIG. 4 illustrates an example method 400 performed by one or more computer storage media storing computer-readable instructions that when executed by a processor, cause the processor to perform a method for detecting network anomalies corresponding to user equipment (UE) performance degradation. The method comprises, at block 410, inputting into a machine learning model a plurality of key performance indicators (KPIs) that are used to measure performance trends of a plurality of UEs. The method further comprises, at block 412, accessing historical data associated with the plurality of KPIs for the plurality of UEs. At block 414, the method further comprises training the machine learning model on the historical data as applied to the KPIs. At block 416, the method further comprises generating, by the machine learning model, output comprising one or more anomalies that indicate that the UE performance degradation has exceeded a threshold.

With reference to FIG. 5, computing device 500 includes a bus 502 that directly or indirectly couples the following devices: memory 504, one or more processors 506, one or more presentation components 508, input/output (I/O) ports 510, input/output (I/O) components 512, and an illustrative power supply 514. Bus 502 represents what may be one or more buses (such as an address bus, data bus, or combination thereof). Although the various blocks of FIG. 5 are shown with lines for the sake of clarity, in reality delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 5 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 5 and may be referred to as “computing device.”

Computing device 500 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and which can be accessed by computing device 500. In contrast to communication media, computer storage media is not a modulated data signal or any signal per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 504 includes computer-storage media in the form of volatile or nonvolatile memory. The memory may be removable, non-removable, or a combination thereof. Example hardware devices include solid-state memory, hard drives, optical-disc drives, etc. Computing device 500 includes one or more processors that read data from various entities, such as memory 504 or I/O components 512. Presentation component(s) 508 present data indications to a user or other device. Example presentation components include a display device, speaker, printing component, vibrating component, etc.

I/O ports 510 allow computing device 500 to be logically coupled to other devices, including I/O components 512, some of which may be built in. Illustrative components include a microphone, joystick, game pad, satellite dish, scanner, printer, wireless device, etc.

Radio 516 represents a radio that facilitates communication with a wireless telecommunications network. In aspects, the Radio 516 utilizes one or more transmitters, receivers, and antennas to communicate with the wireless telecommunications network on a first downlink/uplink channel. Though only one radio is depicted in FIG. 5, it is expressly conceived that the computing device 500 may have more than one radio or more than one transmitter, receiver, and antenna for the purposes of communicating with the wireless telecommunications network on multiple discrete downlink/uplink channels, at one or more wireless nodes. Illustrative wireless telecommunications technologies include CDMA, GPRS, TDMA, GSM, and the like. Radio 516 might additionally or alternatively facilitate other types of wireless communications, including Wi-Fi, WiMAX, LTE, or other VoIP communications. As can be appreciated, in various embodiments, Radio 516 can be configured to support multiple technologies, or multiple radios can be utilized to support multiple technologies. A wireless telecommunications network might include an array of devices, which are not shown, so as not to obscure more relevant aspects of the invention. Components such as a base station, a communications tower, or even access points (as well as other components) can provide wireless connectivity in some embodiments.

For purposes of this disclosure, the word “including,” “having,” or a variation thereof, has the same broad meaning as the word “comprising,” and the word “accessing” comprises “receiving,” “referencing,” or “retrieving. ” Further, the word “communicating” has the same broad meaning as the word “receiving” or “transmitting” facilitated by software or hardware-based buses, receivers, or transmitters using communication media. Also, the word “initiating” has the same broad meaning as the word “executing or “instructing,” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

The subject matter of the present technology is described with specificity herein to meet statutory requirements. However, the description itself is not intended to limit the scope of this disclosure. Rather, the inventors have contemplated that the claimed or disclosed subject matter might also be embodied in other ways to include different steps or combinations of steps similar to the ones described in this document and in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

From the foregoing, it will be seen that this technology is one well adapted to attain all the ends and objects described above, including other advantages that are obvious or inherent to the structure. It will be understood that certain features and sub-combinations are of utility and may be employed without reference to other features and sub-combinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

1. A computerized method performed by one or more processors for detecting network anomalies corresponding to user equipment (UE) performance degradation, the method comprising:
inputting into a machine learning model historical data as applied to a plurality of key performance indicators (KPIs) that are used to measure performance trends of a plurality of UEs;
accessing data associated with the plurality of KPIs for the plurality of UEs; and
training the machine learning model on the historical data as applied to the KPIs to receive output by the machine learning model, the output comprising one or more anomalies that indicate that the UE performance degradation has exceeded a threshold.

2. The method of claim 1, wherein the plurality of KPIs relate to frequency, intensity, relativity, sensitivity, or time of degraded customer experience.

3. The method of claim 1, wherein the historical data associated with the plurality of KPIs for the plurality of UEs includes network related churn data.

4. The method of claim 1, further comprising:
determining a plurality of impact zones for the UE.

5. The method of claim 4, further comprising:
determining a threshold impact zone of the plurality of impact zones has been exceeded.

6. The method of claim 5, further comprising:
determining a plurality of UEs have exceeded the threshold impact zone.

7. The method of claim 6, wherein determining the threshold impact zone has been exceeded further comprises generating, using the machine learning model, an actionable field task.

8. The method of claim 7, further comprising:
identifying one or more cells for optimization.

9. The method of claim 8, further comprising:
prioritizing the one or more cells for optimization.

10. One or more computer storage media storing computer-readable instructions that when executed by a processor, cause the processor to perform a method for detecting network anomalies corresponding to user equipment (UE) performance degradation, the method comprising:
inputting into a machine learning model a plurality of key performance indicators (KPIs) that are used to measure performance trends of a plurality of UEs;
accessing historical data associated with the plurality of KPIs for the plurality of UEs;
training the machine learning model on the historical data as applied to the KPIs; and
generating, by the machine learning model, output comprising one or more anomalies that indicate that the UE performance degradation has exceeded a threshold.

11. The method of claim 10, wherein the KPIs relate to frequency, intensity, relativity, sensitivity, or time of degraded customer experience.

12. The method of claim 10, wherein the historical data associated with the plurality of KPIs for the plurality of UEs includes network related churn data.

13. The method of claim 10, wherein determining the threshold has been exceeded further comprises identifying an actionable field task.

14. The method a of claim 13, further comprising:
identifying one or more cells for optimization.

15. The method of claim 14, further comprising:
prioritizing the one or more cells for optimization.

16. A system for detecting network anomalies corresponding to user equipment (UE) performance degradation, the system comprising:
at least one processor;
one or more computer storage media having computer-usable instructions embodied thereon that when executed by the at least one processor, cause the at least one processor to:
determine a plurality of impact zones for a UE using a trained impact zone model, the trained impact zone model having been trained on a series of historical data associated with performance trend outputs of a trained neural network configured to generate performance trends in response to historical data associated with a plurality of key performance indicators (KPIs);
determine an impact zone threshold for the UE using the trained neural network, wherein the impact zone threshold is determined by the trained neural network in response to receiving historical data associated with a plurality of UEs;
determine current performance trends for the UE using the trained neural network, wherein the current performance trends are determined by the trained neural network in response to receiving current KPIs for a UE; and
identify current performance trends which exceed the impact zone threshold.

17. The system of claim 16, wherein the KPIs relate to frequency, intensity, relativity, sensitivity, or time of degraded customer experience.

18. The system of claim 16, wherein identifying current performance trends which exceed the impact zone threshold further comprises identifying an actionable field task.

19. The system of claim 18, wherein the processors are further caused to identify one or more cells for optimization.

20. The system of claim 19, wherein the processors are further caused to prioritize the one or more cells for optimization.
